(19) United States
(12) Patent Application Publication
(10) Pub. No.: US 2015/0248837 A1
(43) Pub. Date: Sep. 3, 2015

(54) System and Method for Warning Lane Departure

(71) Applicant: Core Logic, Inc., Seoul (KR)

(72) Inventor: ByungHo Kim, Suwon-si (KR)

(73) Assignee: Core Logic, Inc.

(21) Appl. No.: 14/602,115

(22) Filed: Jan. 21, 2015

(30) Foreign Application Priority Data
Feb. 28, 2014 (KR) 2014-0024569

(51) Int. Cl. G08G 1/16; H04N 7/18

(52) U.S. Cl. CPC G08G 1/167; H04N 7/18; G06T 2207/30256

(57) ABSTRACT

A system for warning lane departure includes a lane extracting module configured to receive a driving image of a vehicle from an image photographing module and generate an extracted lane image by removing an image other than a lane from the input image at least partially to extract a lane, a lane recognizing module configured to draw a linear functional formula corresponding to the extracted lane from the extracted lane image generated by the lane extracting module, and a lane departure determining module configured to determine lane departure of a vehicle by using the linear functional formula drawn by the lane recognizing module.

### CROSS-REFERENCE TO RELATED APPLICATION

The present application claims priority to Korean Patent Application No. 10-2014-0024569 filed on Feb. 28, 2014 in the Republic of Korea, the disclosures of which are incorporated herein by reference.

### BACKGROUND OF THE DISCLOSURE

1. Field of the Disclosure

The present disclosure relates to a lane departure detection technique, and more particularly, to a system and method for recognizing a lane rapidly and accurately from a vehicle driving image input through a camera sensor such as a vehicle black box and then detecting and warning lane departure of the vehicle through the recognized lane.

2. Description of the Related Art

Recently, various devices are being introduced to a vehicle to enhance convenience of a driver and safety of a vehicle which is running. Among them, a lane departure warning device for detecting lane departure of a vehicle driving on a road and notifying lane departure information to a driver is representative.

If a driving image is input through a camera sensor such as a black box, an existing lane departure technique representatively uses Hough transformation to recognize a lane from the input image and detect lane departure. In the Hough transformation, a lane in an X-Y coordinate system is converted into a θ-ρ coordinate system to detect the lane, thereby analyzing a location of the lane. This Hough transformation will be described in more detail with reference to FIG. 1.

FIG. 1 is a diagram for illustrating how to convert an X-Y coordinate system into a θ-ρ coordinate system according to an existing Hough transformation.

Referring to FIG. 1, a following equation may be established between the X-Y coordinate system and the θ-ρ coordinate system.

ρ=x cos θ+y sin θ

If a technique for detecting deviation from a lane according to the Hough transformation is used, a lane of the X-Y coordinate system is converted into the θ-ρ coordinate system to detect the lane. In other words, while changing θ and ρ, a line where an edge of the lane intersects with the equation is detected, thereby obtaining an equation of a lane in the θ-ρ coordinate system. In addition, in order to analyze a location of the detected lane, the θ-ρ coordinate system is inversely converted into the X-Y coordinate system (inverse Hough transformation) to obtain a location of the lane.

However, if the Hough transformation is used for analyzing a location of a lane and detecting lane departure, the Hough transformation and its inverse transformation should be performed, and many trigonometrical functions should be used, which requires a lot of calculations and thus results in a slow calculation rate. For this reason, in order to suitably deal with such a lot of calculations, a high-performance CPU is required, and power consumption also increases.

In addition, in a part of the existing lane departure technique, in order to enhance a lane departure rate, a specific partial area of an image input through a camera sensor is designated as an interested area, and a lane is detected within the interested area. However, in this technique, since the interested area is fixed, if an actual lane is out of the interested area, the actual lane may not be accurately detected, and unnecessary interested area may be excessively present according to a location of the lane, and thus there is a limit in enhancing accuracy and rate in lane departure detection.

### SUMMARY OF THE DISCLOSURE

The present disclosure is directed to providing a system and method for warning lane departure, which may have a small amount of calculations and may improve rate, energy efficiency and accuracy in lane recognition by flexibly correcting an interested area.

Other advantages of the present disclosure will be understood from the following descriptions and become apparent by the embodiments of the present disclosure. In addition, it is understood that advantages of the present disclosure may be implemented by components defined in the appended claims or their combinations.

In one aspect of the present disclosure, there is provided a system for warning lane departure, which includes a lane extracting module configured to receive a driving image of a vehicle from an image photographing module and generate an extracted lane image by removing an image other than a lane from the input image at least partially to extract a lane; a lane recognizing module configured to draw a linear functional formula corresponding to the extracted lane from the extracted lane image generated by the lane extracting module; and a lane departure determining module configured to determine lane departure of a vehicle by using the linear functional formula drawn by the lane recognizing module.

Preferably, the lane extracting module may receive the driving image as a gray image from the image photographing module, and generate the extracted lane image as a binary-coded image.

Also preferably, the lane extracting module may include a road brightness calculating unit configured to receive the gray image and calculate a brightness threshold; a brightness-based filtering unit configured to extract only pixels having brightness over the brightness threshold from the gray image and generate a binary-coded image by using the extracted pixels; and a width-based filtering unit configured to compare widths of the pixels extracted by the brightness-based filtering unit with a reference width range and remove a pixel having a width out of the reference width range from the binary-coded image.

Also preferably, the road brightness calculating unit may divide a portion corresponding to the road into a plurality of regions, calculate mean pixel brightness in each region, and calculate a brightness threshold based on the mean pixel brightness.

Also preferably, the width-based filtering unit may calculate a ratio of a lane width to a road width, compare the calculated ratio with a reference ratio range, and remove a pixel whose ratio is out of the reference ratio range from the binary-coded image.

Also preferably, the lane recognizing module may include a lane edge extracting unit configured to extract a lane edge of the extracted lane from the extracted lane image; a lane detecting unit configured to draw a linear functional formula between x and y, corresponding to the extracted lane edge, based on an X-Y coordinate system in which a horizontal axis of the extracted lane image is an x axis and a vertical axis is a y axis; and a lane location analyzing unit configured to analyze a location of the lane by using the drawn linear functional formula.

Also preferably, the lane recognizing module may further include an interested area setting unit configured to set an interested area for the image by using the linear functional formula drawn by the lane detecting unit, and lane extracting module may extract the lane within the interested area set by the interested area setting unit.

Also preferably, when two linear functional formulas are drawn by the lane detecting unit, the interested area setting unit may calculate an intersection point of the two linear functional formulas as a vanishing point, and set the interested area by using the calculated vanishing point.

Also preferably, the interested area setting unit may set a y-axis coordinate value of the vanishing point as a y-axis coordinate upper limit of the interested area, search a y-axis coordinate value of a hood of the vehicle, and set the searched y-axis coordinate value of the hood as a y-axis coordinate lower limit of the interested area.

Also preferably, the interested area setting unit may correct a preset interested area by using a location of the vanishing point and width information of the road.

Also preferably, the lane detecting unit may draw a following equation as the linear functional formula between x and y:

x=a×(y−y_{b})+x_{d}

where x and y are variables, a is a constant representing a ratio of an increment of x to an increment of y, y_{b} represents a y-axis coordinate lower limit of the interested area, and x_{d} represents a x-axis coordinate value of the linear functional formula at a lower limit of the interested area.

Also preferably, the lane detecting unit may move a point t located at the upper limit of the interested area and a point d located at the lower limit of the interested area in a horizontal direction, respectively, and when a number of pixels overlapping with the lane edge extracted by the lane edge extracting unit is greatest, an equation between x and y for a line connecting the points t and d may be drawn as the linear functional formula.

Also preferably, the lane detecting unit may draw a following equation as the linear functional formula;

$$x = \frac{( {x}_{d} - {x}_{t} )}{( {y}_{b} - {y}_{v} )} \times ( y - {y}_{b} ) + {x}_{d}$$

where x and y are variables, xₜ and yᵥ represent an x-axis coordinate value and a y-axis coordinate value of the point t, and x_{d} and y_{b} represent an x-axis coordinate value and a y-axis coordinate value of the point d.

Also preferably, the lane departure determining module may include a warning threshold calculating unit configured to calculate a warning threshold value for a location of the lane; and a lane departure determining unit configured to compare the location of the lane recognized by the lane recognizing module with the warning threshold value calculated by the warning threshold calculating unit and determine lane departure based on the comparison result.

Also preferably, the warning threshold calculating unit may calculate the warning threshold value in proportion to the width of the road.

Also preferably, the warning threshold calculating unit may calculate a maximum warning threshold value located at a right side of the lane and a minimum warning threshold value located at a left side of the lane, and the lane departure determining unit may determine that the vehicle makes lane departure when the location of the lane moves from the left side of the maximum warning threshold value to the right side of the maximum warning threshold value or moves from the right side of the minimum warning threshold value to the left side of the minimum warning threshold value.

Also preferably, the system for warning lane departure may further include a warning module configured to provide a user with warning information when the lane departure determining module determines that the vehicle makes lane departure.

In another aspect, there is also provided a method for warning lane departure, which may include receiving a driving image of a vehicle from an image photographing module; generating an extracted lane image by removing an image other than a lane from the input image at least partially to extract a lane; drawing a linear functional formula corresponding to the extracted lane from the extracted lane image generated above; and determining lane departure of a vehicle by using the drawn linear functional formula.

In one aspect of the present disclosure, since an amount of calculations for a lane recognition process and a lane departure detection process is small, a calculation rate may be improved in comparison to an existing technique.

In particular, if the present disclosure is used, in an X-Y coordinate system, a linear functional formula between x and y is used to recognize a lane and detect lane departure, and Hough transformation and inverse Hough transformation using trigonometrical functions may not be used, different from the existing technique.

Therefore, in this aspect of the present disclosure, a lane recognition rate and a lane departure detection rate may be effectively improved, and power consumption for calculations is not so great, thereby improving energy efficiency. In addition, in this aspect of the present disclosure, since a high-performance CPU is not required, a manufacture cost may be reduced. In particular, in order to implement the present disclosure, a general-purpose CPU may be used, and further a floating point unit (FPU) included in such a general-purpose CPU may also be used, which may enhance a calculation rate.

In addition, in one aspect of the present disclosure, in a vehicle driving image input through a camera sensor such as a black box, an interested area serving as an effective area for detecting a lane is not fixed, and the interested area may be corrected depending on situations.

Therefore, in this aspect of the present disclosure, even though a view angle or installation position of a camera is changed like a detachable image photographing device or various road situations such as a road curvature or a road width are changed, the interested area may be flexibly corrected, thereby enhancing accuracy in lane recognition and reducing an amount of calculations.

### BRIEF DESCRIPTION OF THE DRAWINGS

The accompanying drawings illustrate embodiments of the present disclosure and, together with the foregoing disclosure, serve to provide further understanding of the technical spirit of the present disclosure. However, the present disclosure is not to be construed as being limited to the drawings. In the drawings:

FIG. 1 is a diagram for illustrating how to convert an X-Y coordinate system into a θ-ρ coordinate system according to an existing Hough transformation;

FIG. 2 is a block diagram schematically showing a functional configuration of a system for warning lane departure (hereinafter, also referred to as a “lane departure warning system”) according to an embodiment of the present disclosure;

FIG. 3 is a diagram showing an example of a driving image photographed by an image photographing module;

FIG. 4 is a block diagram schematically showing a functional configuration of a lane extracting module according to an embodiment of the present disclosure;

FIG. 5 is a schematic diagram showing a configuration for calculating a brightness threshold by a road brightness calculating unit according to an embodiment of the present disclosure;

FIG. 6 is a block diagram schematically showing a functional configuration of a lane recognizing module according to an embodiment of the present disclosure;

FIG. 7 is a diagram schematically showing a process of drawing a linear functional formula corresponding to a lane edge detected by a lane detecting unit on the X-Y coordinate system;

FIG. 8 is a diagram schematically showing an interested area set for a driving image according to an embodiment of the present disclosure;

FIG. 9 is a diagram schematically showing a process of drawing a linear functional formula corresponding to a lane in an interested area of a driving image according to an embodiment of the present disclosure;

FIG. 10 is a diagram schematically showing a process of correcting an interested area according to an embodiment of the present disclosure;

FIG. 11 is a diagram schematically showing a functional configuration of a lane departure determining module according to an embodiment of the present disclosure;

FIG. 12 is a diagram schematically showing a lane departure determining configuration of a lane departure determining module to an embodiment of the present disclosure; and

FIG. 13 is a schematic flowchart for illustrating a method for warning lane departure according to an embodiment of the present disclosure.

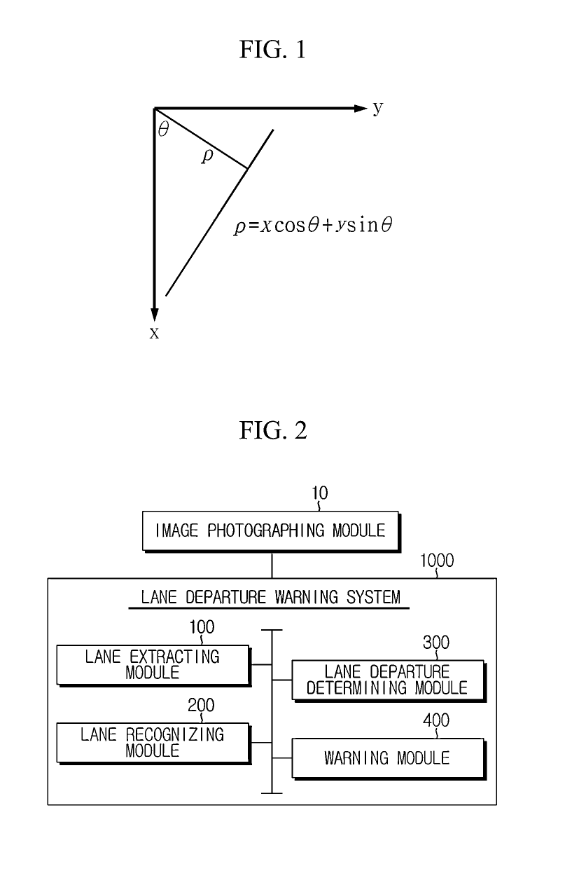

### DETAILED DESCRIPTION

Hereinafter, embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just an example for the purpose of illustrations only, not intended to limit the scope of the disclosure, so it should be understood that other equivalents and modifications could be made thereto without departing from the spirit and scope of the disclosure.

FIG. 2 is a block diagram schematically showing a functional configuration of a system 1000 for warning lane departure (hereinafter, also referred to as a “lane departure warning system 1000”) according to an embodiment of the present disclosure.

Referring to FIG. 2, the lane departure warning system 1000 according to the present disclosure includes a lane extracting module 100, a lane recognizing module 200 and a lane departure determining module 300. In addition, the lane departure warning system 1000 may use an image photographed by an image photographing module 10 in order to realize its function.

In the specification, the term “lane” generally means various lines representing a running direction of a vehicle, and may include not only a traffic lane for distinguishing paths of vehicles running on the same road in the same direction, such as a first lane, a second lane or the like, but also other kinds of lanes such as a centerline, a shoulder line, a line for limiting the change of course, a U-turn line, an exclusive lane, a guide lane or the like.

First, the image photographing module 10 for providing an image to the lane departure warning system may photograph a driving image of a vehicle.

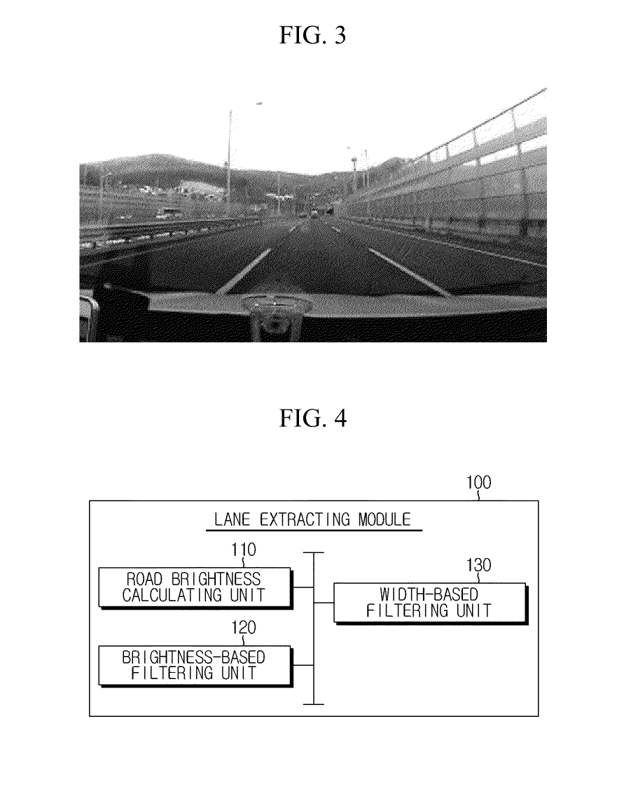

FIG. 3 is a diagram showing an example of the driving image photographed by the image photographing module 10.

As shown in FIG. 3, the image photographing module 10 is an element capable of photographing a vehicle driving image by using a camera sensor, similar to an existing vehicle black box. However, the present disclosure is not limited to a specific example of the image photographing module 10, and various devices capable of photographing an image may be used as the image photographing module 10. For example, an existing vehicle black box and other devices capable of photographing an image such as a cellular phone, a notebook, a tablet PC or the like may be used as the image photographing module 10.

Meanwhile, even though FIG. 2 shows as if the image photographing module 10 is not included in the lane departure warning system of the present disclosure, the image photographing module 10 may also be included as a component of the lane departure warning system according to the present disclosure. In this case, the lane departure warning system according to the present disclosure may directly photograph an image used for warning lane departure.

If a driving image of a vehicle is photographed by the image photographing module 10 as shown in FIG. 2, the lane extracting module 100 receives the photographed vehicle driving image from the image photographing module 10. In addition, the lane extracting module 100 extracts a lane by partially removing images other than a lane, from the input image.

Therefore, the lane extracting module 100 may extract an extracted lane image by extracting a lane from the driving image. However, the extracted lane image may include other marks such as a road sign or a vehicle light in addition to the lane.

Preferably, the lane extracting module 100 may receive the driving image of a vehicle as a gray-level image. In addition, the lane extracting module 100 may generate the extracted lane image as a binary-coded image. For example, the lane extracting module 100 may generate a binary-coded image by removing other images than the lane from the gray image input by the image photographing module 10.

FIG. 4 is a block diagram schematically showing a functional configuration of the lane extracting module 100 according to an embodiment of the present disclosure.

Referring to FIG. 4, the lane extracting module 100 may include a road brightness calculating unit 110, a brightness-based filtering unit 120 and a width-based filtering unit 130.

The road brightness calculating unit 110 may receive the driving image input by the image photographing module 10 to calculate brightness threshold. In particular, the road brightness calculating unit 110 may receive a gray image from the image photographing module 10, calculate mean brightness of a region corresponding to a road bottom such as asphalt, and calculate a brightness threshold based on the brightness. At this time, it may be determined whether the region corresponds to a road bottom, on the basis of information input by the lane recognizing module 200 or a predetermined region of the driving image.

FIG. 5 is a schematic diagram showing a configuration for calculating a brightness threshold by the road brightness calculating unit 110 according to an embodiment of the present disclosure.

Referring to FIG. 5, the road brightness calculating unit 110 may designate a portion corresponding to a road, as indicated by R in the gray image, as a plurality of regions. In other words, the road brightness calculating unit 110 may divide a portion corresponding to a road except for a lane, as indicated by L, into a plurality of block regions. In addition, the road brightness calculating unit 110 may calculate mean pixel brightness in each region and calculate a brightness threshold of a pixel corresponding to the lane and road sign based on the calculated mean pixel brightness. For example, the road brightness calculating unit 110 may calculate brightness greater over a predetermined level than a mean value of pixel brightness corresponding to asphalt in each block as the brightness threshold. In this case, the present disclosure may be strong against shade or other noise of a road. Meanwhile, the road brightness calculating unit 110 may input the lane information recognized by the lane recognizing module 200 in a former process and designate a portion corresponding to a road as a block.

The brightness-based filtering unit 120 may remove noise other than the road based on brightness of pixels. In particular, the brightness-based filtering unit 120 may remove road signs other than the lane by using the brightness threshold calculated by the road brightness calculating unit 110. For example, the brightness-based filtering unit 120 may extract pixels having brightness over the brightness threshold from the gray image input by the image photographing module 10 and generate a binary-coded image by using only the extracted pixels.

Here, when extracting pixels having brightness over the brightness threshold calculated by the road brightness calculating unit 110, the brightness-based filtering unit 120 may remove pixels greatly higher than the brightness threshold from the binary-coded image. At this time, the brightness threshold may be regarded as a maximum brightness value representing a lane on a road. Therefore, a pixel having such brightness higher than a maximum lane brightness value is highly likely to be a headlight or tail light of a vehicle or another light source such as a nearby building. For this reason, in order to distinguish such a light source from a lane, the brightness-based filtering unit 120 may consider that a pixel having brightness greatly higher than the brightness threshold has no relation with a lane, and remove the corresponding pixel from the binary-coded image.

For example, the brightness-based filtering unit 120 may designate brightness higher than the brightness threshold over a predetermined level as a light source threshold, and remove a pixel over the light source threshold from pixels displayed in the binary-coded image. In this case, the brightness-based filtering unit 120 may generate a binary-coded image by extracting only pixels having brightness between the brightness threshold and the light source threshold.

Preferably, the road brightness calculating unit 110 may adjust the brightness threshold based on information fed back from the lane recognizing module 200.

For example, when information notifying that a lane is not recognized is received from the lane recognizing module 200, the road brightness calculating unit 110 may set the brightness threshold to be lower than a previous stage. In other case, when information notifying that noise over a normal level is recognized is received from the lane recognizing module 200, the road brightness calculating unit 110 may set the brightness threshold to be higher than a previous stage.

The width-based filtering unit 130 may remove noise other than the lane based on a width, with respect to the pixels extracted by the brightness-based filtering unit 120. As described above, since the brightness-based filtering unit 120 generates a binary-coded image for pixels extracted based on brightness, the generated binary-coded image may include pixels not only for the lane but also various road marks other than the lane. The width-based filtering unit 130 may remove various marks other than the lane from the binary-coded image as noise.

For example, a left turn mark, a right turn mark, a U-turn mark, a speed limit mark, various guide signs or the like may be included in a road as roam marks in addition to lane marks. Road marks other than lane marks may have brightness similar to the lane marks, and thus such road marks other than lane marks may not be removed by the brightness-based filtering unit 120. Therefore, the width-based filtering unit 130 may distinguish lane marks from other road marks based on a width of each road mark in the pixels included in the binary-coded image.

In particular, for the binary-coded image in which only specific pixels are extracted by the brightness-based filtering unit 120, the width-based filtering unit 130 may remove a pixel for a mark having a width greater than or smaller than a predetermined level, among the marks included in the binary-coded image. In other words, the width-based filtering unit 130 may compare a width of a pixel extracted by the brightness-based filtering unit 120 with a reference width range, and remove a pixel having a width out of the range not to be displayed in the binary-coded image.

For example, if the reference width range is set to be 20 to 30, the width-based filtering unit 130 may determine a road sign having a width smaller than 20 or greater than 30 as a noise, which is not a lane, and remove a pixel for the road sign from the binary-coded image.

Preferably, the width-based filtering unit 130 may distinguish a lane from other road marks based on a ratio of a lane width to a road width. In other words, the width-based filtering unit 130 may calculate a ratio of a lane width to a road width, compare the calculated ratio with a reference ratio range, and remove a pixel corresponding to a mark having a ratio out of the reference ratio range from the binary-coded image. Here, the reference ratio range may be set based on, for example, “Manual for installation and management of traffic road marks by the National Police Agency”.

If the extracted lane image is generated by the lane extracting module 100, the lane recognizing module 200 draws a linear functional formula corresponding to the extracted lane from the extracted lane image generated above. In particular, the lane recognizing module 200 may detect a lane in the binary-coded image from which images corresponding to road marks other than the lane are removed by the lane extracting module 100, and analyze its location to notify lane detection and a location of the detected lane.

In addition, the lane recognizing module 200 may enhance an extraction rate of lane candidates by providing interested area information to the lane extracting module 100, and also enhance accuracy in lane candidate extraction by notifying detection of a lane and detection of noise to the lane extracting module 100. Moreover, the lane recognizing module 200 may enhance accuracy of lane departure determination by providing slope information, location information or the like of the lane to the lane departure determining module 300.

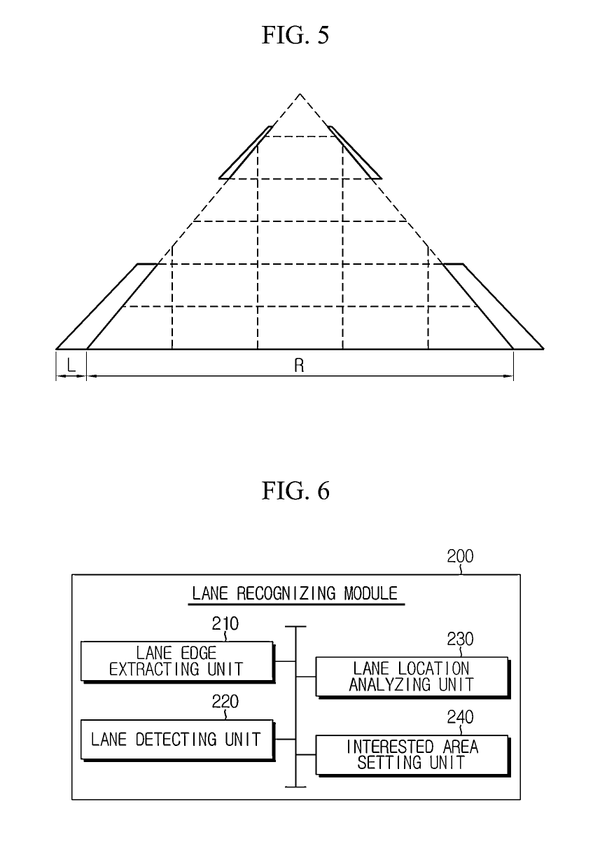

FIG. 6 is a block diagram schematically showing a functional configuration of the lane recognizing module 200 according to an embodiment of the present disclosure.

Referring to FIG. 6, the lane recognizing module 200 may include a lane edge extracting unit 210, a lane detecting unit 220 and a lane location analyzing unit 230.

The lane edge extracting unit 210 extracts edges of a lane from the extracted lane image generated by the lane extracting module 100. Generally, a lane has a rectangular shape with four sides, and each lane may be configured with edges including a left side, a right side, an upper side and a lower side. Therefore, the lane edge extracting unit 210 may extract a left line, a right line, an upper line and a lower line as edges of the lane. However, if the lane is a solid line, the lane edge extracting unit 210 may also extract only a left line and a right line as edges of the lane for a predetermined time.

In particular, the lane edge extracting unit 210 may extract edges of a lane by means of a canny algorithm, without being limited thereto.

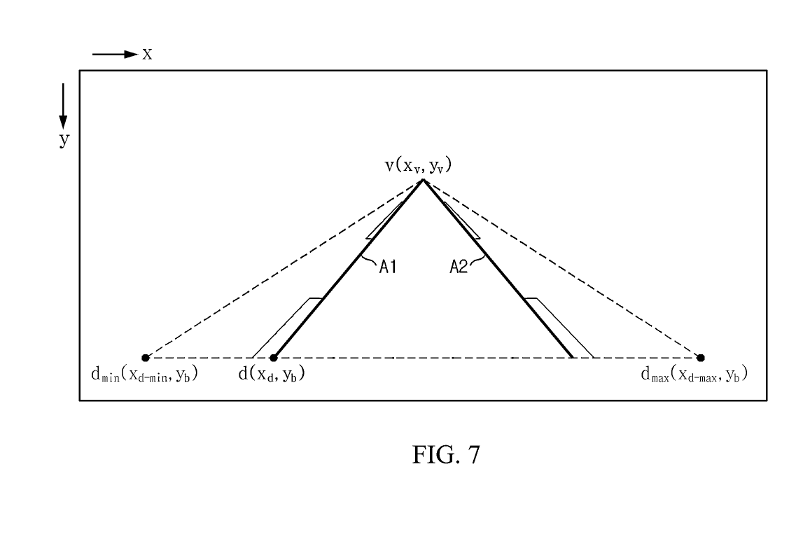

The lane detecting unit 220 draws a linear functional formula between x and y corresponding to the lane edge extracted by the lane edge extracting unit 210, based on an X-Y coordinate system with respect to the extracted lane image. A process of drawing a formula for a lane by the lane detecting unit 220 will be described in more detail below with reference to FIG. 7.

FIG. 7 is a diagram schematically showing a process of drawing a linear functional formula corresponding to a lane edge detected by the lane detecting unit 220 on the X-Y coordinate system.

As shown in FIG. 7, the extracted lane image obtained by extracting a lane from the driving image of a vehicle by the lane extracting module 100 may be generated as a binary-coded image, and the lane edge extracting unit 210 may extract only an edge of the lane from the extracted lane image. The lane detecting unit 220 may draw a formula for a lane edge on an X-Y coordinate system for the image from which the lane is extracted as described above.

In other words, a location of each pixel in the extracted lane image may be explained on the X-Y coordinate system in which a horizontal axis is an x axis and a vertical axis is a y axis. At this time, an origin point where the x axis and y axis intersect may be at a left top point of the extracted lane image as shown in FIG. 5.

The lane detecting unit 220 may draw a linear functional formula between x and y corresponding to the lane edge based on the X-Y coordinate system with respect to the extracted lane image. Here, since the linear functional formula represents a straight line on the X-Y coordinate system, the lane detecting unit 220 may be regarded as drawing a straight line corresponding to the lane edge. At this time, the lane detecting unit 220 may draw a straight line corresponding to an inner line among edges of a lane. Here, the inner line means a line close to a vertical center axis of a vehicle with respect a single lane. For example, the inner line may be a right line based on a left lane edge, and the inner line may also be a left line based on a right lane edge.

In particular, the lane detecting unit 220 may draw a formula about a straight line having a greatest amount of pixels overlapping with the extracted lane edge in the lane image as a linear functional formula corresponding to the lane edge.

For example, in the embodiment of FIG. 7, the lane detecting unit 220 may figure out a straight line A1 having a greatest amount of pixels overlapping with an edge of a left lane as a straight line corresponding to the left lane in the extracted lane image. In addition, the lane detecting unit 220 may draw a formula corresponding to the straight line A1 as a linear functional formula corresponding to the left lane.

At this time, the lane detecting unit 220 may draw the linear functional formula corresponding to the left lane by using Equation 1 below on the X-Y coordinate system of FIG. 5.

x=a×(y−y_{b})+x_{d} Equation 1

where x and y are variables on the X-Y coordinate system, a represents a slope of the straight line A1, and x_{d} and y_{b} represent a coordinate of an arbitrary point d.

Meanwhile, the lane detecting unit 220 may figure out a straight line A2 having a greatest amount of pixels overlapping with an edge of a right lane, as a straight line corresponding to the right lane in the extracted lane image. In addition, the lane detecting unit 220 may draw a formula corresponding to the straight line A2 as a linear functional formula corresponding to the right lane.

Here, the slope a of Equation 1 may be expressed as follows by using two points on the X-Y coordinate system, namely v (xᵥ, yᵥ) and d (x_{d}, y_{b}).

$$a = \frac{( {x}_{d} - {x}_{v} )}{( {y}_{b} - {y}_{v} )} \qquad Equation 2$$

Therefore, if Equation 2 is applied to Equation 1, Equation 1 may be arranged as follows.

$$x = \frac{( {x}_{d} - {x}_{v} )}{( {y}_{b} - {y}_{v} )} \times ( y - {y}_{b} ) + {x}_{d} \qquad Equation 3$$

Equation 3 may be regarded as expressing Equation 1 with locations of two points (the point v and the point d) on the X-Y coordinate system.

Meanwhile, as shown in FIG. 7, the point v (xᵥ, yᵥ) may be an intersection point between the straight line A1 corresponding to the left lane and the straight line A2 corresponding to the right lane, and in this case, the intersection point v may be regarded as corresponding to a vanishing point of the driving image. In addition, since the lane projected on the image converges to the vanishing point, the lane detecting unit 220 may use the vanishing point when drawing a linear functional formula corresponding to the lane afterwards. In other words, the lane detecting unit 220 may find a straight line corresponding to the left lane and its linear functional formula, while changing a slope of the straight line A1 based on the vanishing point v. In addition, the lane detecting unit 220 may find a straight line corresponding to the right lane and its linear functional formula, while changing a slope of the straight line A2 based on the vanishing point v.

The lane location analyzing unit 230 analyzes a location of the lane by using the linear functional formula drawn by the lane detecting unit 220. In particular, the lane location analyzing unit 230 may analyze a point on the straight line corresponding to the lane as a location of the lane.

For example, in the embodiment of FIG. 7, the lane location analyzing unit 230 may recognize any one point on the straight line corresponding to the left lane, for example x_{d} which is an x coordinate of the point d based on the point d whose y coordinate is y_{b}, as a location of the lane.

The lane location analyzing unit 230 may recognize a location of the left lane and a location of the right lane separately. In addition, from the locations of the left lane and the right lane, a width of the road may be obtained. At this time, the lane location analyzing unit 230 compares the obtained width of the road with a reference road width. If the width of the road is smaller than the reference value, the lane location analyzing unit 230 may determine that a road mark or the like other than a lane is erroneously recognized as a lane, and notify this to another component, for example the lane detecting unit 220 or the like.

In addition, if it is determined that the analyzed location of the lane is at a center of the road and the lane has a slope close to a vertical direction, the lane location analyzing unit 230 may determine that a road mark other than a lane is erroneously recognized as a lane.

Preferably, the lane recognizing module 200 may further include an interested area setting unit 240 as shown in FIG. 6.

The interested area setting unit 240 sets an interested area in a driving image. Here, the interested area may be regarded as meaning an effective area for recognizing a lane is from the driving image. Therefore, areas of the driving image other than the interested area may be regarded as non-interested areas, namely areas from which a lane is not to be recognized.

Therefore, in this configuration of the present disclosure, it is possible to recognize a lane and detect lane departure only within an effective interested area, which may reduce an amount of calculations.

In particular, in the present disclosure, if a linear functional formula corresponding to a lane is drawn by the lane detecting unit 220, the interested area setting unit 240 may set an interested area for the driving image by using the linear functional formula.

If so, other components of the lane recognizing module 200, for example the lane edge extracting unit 210, the lane detecting unit 220 and the lane location analyzing unit 230, may operate based on the set interested area.

In addition, the lane extracting module 100 may extract a lane within the interested area set by the interested area setting unit 240.

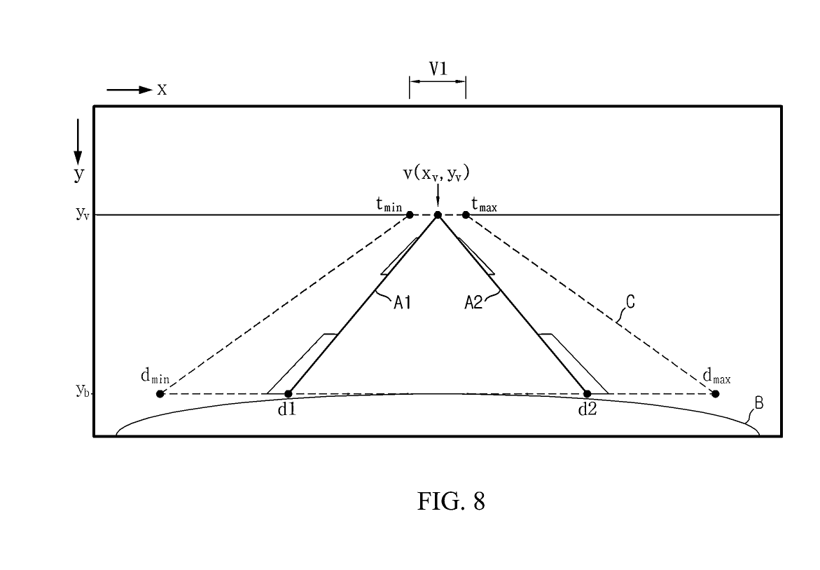

FIG. 8 is a diagram schematically showing an interested area set for a driving image according to an embodiment of the present disclosure.

Referring to FIG. 8, the interested area setting unit 240 may set a region marked by a dotted line C in the driving image as the interested area. If so, the lane extracting module 100 may extract a lane only within the interested area (marked by the dotted line C) of the driving image input by the image photographing module 10 and generate an extracted lane image.

In this configuration of the present disclosure, since a lane is extracted only within the interested area of the driving image, it is possible to improve a rate and accuracy of lane extracting operation and reduce a load applied to the lane extracting module 100.

In particular, the interested area set by the interested area setting unit 240 may have an upper limit and a lower limit and may also have a trapezoidal shape in consideration of a perspective feeling.

Preferably, if the lane detecting unit 220 draws two linear functional formulas, the interested area setting unit 240 may an intersection point of the two linear functional formulas as a vanishing point and set an interested area by using the calculated vanishing point.

For example, as shown in FIG. 8, the driving image may have a left lane and a right lane based on a vehicle, and the left lane and the right lane may converge to the vanishing point. Therefore, a formula of a straight line A1 corresponding to the left lane and a formula of a straight line A2 corresponding to the right lane may have different slopes and intersect at an intersection point v (xᵥ, yᵥ). At this time, the intersection point v may be regarded as a vanishing point of the driving image. Therefore, the interested area setting unit 240 may consider an intersection point of linear functional formulas for two straight lines corresponding to the left lane and the right lane as a vanishing point and then set an interested area by using the vanishing point.

In particular, the interested area setting unit 240 may set a y-axis coordinate value of the vanishing point v as a y-axis coordinate upper limit of the interested area. In other words, in the embodiment of FIG. 8, since the y-axis coordinate value of the vanishing point v is yᵥ, yᵥ may be set as the y-axis coordinate upper limit of the interested area. Here, the y-axis coordinate upper limit of the interested area may be a y-axis coordinate value for an upper limit of the interested area in the driving image. Therefore, the upper limit of the interested area may also be a part of the straight line y=yᵥ.

Meanwhile, the interested area setting unit 240 may set a point tₘᵢₙ and a tₘₐₓ. respectively spaced apart from the vanishing point in a right and left horizontal direction as much as predetermined pixels (distance), namely as much as indicated by v1 in FIG. 8, as a left limit and a right limit of the interested area. The left limit and the right limit for the upper limit of the interested area may be regarded as margins in consideration of the possibility of change of the vanishing point in a next image.

In addition, the interested area setting unit 240 may recognize a hood of the vehicle, searches a y-axis coordinate value of the recognized hood and set the searched y-axis coordinate value of the hood as a y-axis coordinate lower limit of the interested area. In other words, as indicated by B in the embodiment of FIG. 8, a driving image photographed by the image photographing device such as a black box may include a hood, and the interested area setting unit 240 may set a y-axis coordinate value y_{b} located at an uppermost portion of the hood as a y-axis coordinate lower limit of the interested area. In this case, the lower limit of the interested area may be a part of the straight line y=y_{b}.

Here, the interested area setting unit 240 may detect a y-axis location y_{b} of the hood by using a horizontal edge extracting algorithm. In particular, in order to improve a hood recognizing speed, the interested area setting unit 240 may search a hook in a lower direction from a point spaced apart downwards from the vanishing point as much as predetermined pixels.

However, a hood may also not be included in an image according to a vertical installation angle of the camera sensor or if the vehicle is a truck, and in this case, the interested area setting unit 240 may not search a hood. If a hood is not searched, the interested area setting unit 240 may set a portion located below the vanishing point by a predetermined distance or a portion above the lower end of the image by a predetermined distance as a lower limit of the interested area in consideration of a vertical image angle of the camera. Like this, the lower limit of the interested area may be determined in various ways.

Meanwhile, as shown in FIG. 8, the interested area setting unit 240 may set a left limit dₘᵢₙ of the lower limit of the interested area so that the left limit of the interested area is located at a left side of the road, and may set a right limit dₘₐₓ of the lower limit of the interested area so that the right limit of the interested area is located at a right side of the road.

For example, as shown in FIG. 8, if it is assumed that an intersection point between the lower limit of the interested area and a straight line corresponding to the left lane is d1 and an intersection point between the lower limit of the interested area and a straight line corresponding to the right lane is d2, the interested area setting unit 240 may receive coordinate information of the points d1 and d2 from the lane location analyzing unit 230. If so, the interested area setting unit 240 may set a point dₘᵢₙ spaced apart from the point d1 in a left direction as much as predetermined pixels as a left limit of the lower limit of the interested area and set a point dₘₐₓ spaced apart from the point d2 in a right direction as much as predetermined pixels as a right limit of the lower limit of the interested area.

Meanwhile, information about a vanishing point and a lane may not be present in an initial operating stage of the system. In addition, even though there is present information about a vanishing point and a lane, this information may include erroneous or wrong data. In this case, the interested area setting unit 240 may set the interested area on the assumption that the vanishing point is present at an arbitrary position in the driving image. In particular, the interested area setting unit 240 may assume that the vanishing point is present at the center of the image. In this case, the interested area setting unit 240 may search a location of a hood from a point spaced apart from the assumed vanishing point in a lower direction by using a horizontal edge extracting algorithm. In addition, the interested area setting unit 240 may set the interested area in a way similar to the above by using the assumed vanishing point and the searched location of the hood.

Preferably, the interested area setting unit 240 may correct a preset interested area. In other words, the interested area setting unit 240 may correct an interested area which is set arbitrarily or based on information obtained by a previous driving image. At this time, the interested area setting unit 240 may use a location of the vanishing point and a width of the road in order to correct the interested area, as described later.

If the interested area is set, or corrected, by the interested area setting unit 240 as described above, each component of the lane extracting module 100, the lane recognizing module 200 and the lane departure determining module 300 may operate based on the interested area.

For example, in the driving image is input by the image photographing module 10, the lane extracting module 100 may extract a lane by using the brightness-based filtering unit 120 and the width-based filtering unit 130, for the image within the interested area among the input driving image.

In addition, the lane recognizing module 200 may extract a lane edge only from an image within the interested area, draw a linear functional formula between x and y corresponding to the extracted lane edge, and analyze a location of the lane therefrom.

In particular, the lane recognizing module 200 may detect a lane while changing a slope of a linear function converging to the vanishing point. For example, if the vanishing point is determined as v (xᵥ, yᵥ) in a previous image as in the embodiment of FIG. 7, the lane detecting unit 220 may detect straight lines respectively corresponding to a left lane and a right lane by placing a straight line so that its one end is fixed to the point v with respect to a next driving image and moving the other end of the straight line along the lower limit of the interested area. In other words, while moving the point d (x_{d}, y_{b}) which is the other end of the straight line from the point dₘᵢₙ to the point dₘₐₓ, the lane detecting unit 220 may detect a straight line closest to the lane, and draw a linear functional formula of the detected straight line.

At this time, the linear functional formula of the straight line conforming to the lane may be equal to Equation 1.

In other words, the lane detecting unit 220 may draw the following equation as a linear functional formula between x and y corresponding to a lane edge.

x=a×(y−y_{b})+x_{d}

Here, x and y are variables, a is a constant representing a ratio of an increment of x to an increment of y, y_{b} represents a y-axis coordinate lower limit of the interested area, and x_{d} represents a x-axis coordinate value of the linear functional formula at the lower limit of the interested area. In particular, x_{d} and y_{b} may be an x coordinate and a y coordinate of the intersection point where the lower limit of the interested area intersects a straight line corresponding to the lane.

Meanwhile, in the linear functional formula corresponding to a lane as in Equation 1, a is as defined in Equation 2. Therefore, the lane detecting unit 220 may express the linear functional formula corresponding to a lane in a form like Equation 3.

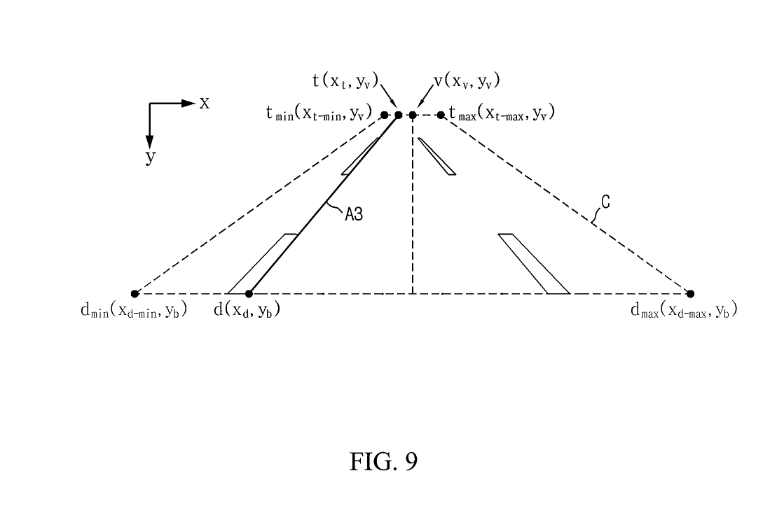

More preferably, in order to draw a linear functional formula corresponding to a lane, the lane detecting unit 220 may be configured to extract a straight line closest to the lane while moving one end of a straight line corresponding to the linear functional formula in a right and left direction within the upper limit of the interested area and moving the other end of the straight line in a right and left direction within the lower limit of the interested area. This will be described in more detail below with reference to FIG. 9.

FIG. 9 is a diagram schematically showing a process of drawing a linear functional formula corresponding to a lane in an interested area of a driving image according to an embodiment of the present disclosure.

Referring to FIG. 9, an interested area C is set for the driving image, and a lane is displayed only within the interested area. The interested area may be set by the interested area setting unit 240, and the interested area setting unit 240 may set the interested area based on a vanishing point v (xᵥ, yᵥ) and a lane extracted from a previous driving image.

In the embodiment of FIG. 9, a y coordinate of the upper limit of the interested area is yᵥ, a left limit of the upper limit is expressed as tₘᵢₙ (yᵥ) and a right limit of the upper limit is expressed as tₘₐₓ (xₜ₋ₘₐₓ, yᵥ). In addition, a y coordinate of the lower limit of the interested area is y_{b}, a left limit of the lower limit is expressed as dₘᵢₙ (x_{d-min}, y_{b}), and a right limit of the lower limit is expressed as dₘₐₓ (x_{d-max}, y_{b}).

In this circumstance, while moving a point t located on the upper limit of the interested area and a point d located on the lower limit of the interested area in a horizontal direction, respectively, the lane detecting unit 220 may draw a formula of a straight line connecting the point t and the point d and having a greatest amount of pixels on the lane edge as a linear functional formula corresponding to the lane. In other words, the lane detecting unit 220 may draw a linear functional formula of a straight line A3 corresponding to the lane while moving the point t between the point tₘᵢₙ and the point tₘₐₓ and moving the point d between the point dₘᵢₙ and the point dₘₐₓ.

Here, based on the embodiment of FIG. 9, the lane detecting unit 220 may draw a linear functional formula corresponding to the lane as follows.

$$x = \frac{( {x}_{d} - {x}_{t} )}{( {y}_{b} - {y}_{v} )} \times ( y - {y}_{b} ) + {x}_{d} \qquad Equation 4$$

where x and y are variables, xₜ and yᵥ represent an x-axis coordinate value and a y-axis coordinate value of the point t, and x_{d} and y_{b} represent an x-axis coordinate value and a y-axis coordinate value of the point d.

Meanwhile, as described above, when drawing a linear functional formula corresponding to a lane, the lane detecting unit 220 may refer to a number of pixels overlapping with the lane edge. In other words, the lane detecting unit 220 may regard a straight line having a greatest number of pixels overlapping with the lane edge as a straight line corresponding to the lane, and draw a formula for the straight line as a linear functional formula corresponding to the lane.

Here, the lane detecting unit 220 may set a lane detection threshold in relation to the number of pixels overlapping with the lane edge. Therefore, even though a straight line has a greatest number of pixels overlapping with the lane edge, if the number of pixels overlapping with the lane edge does not exceed the lane detection threshold, the lane detecting unit 220 may regard that the straight lane is not a straight line corresponding to the lane and thus the lane is not detected. In addition, if many lane formulas exceeding the lane detection threshold are detected, the lane detecting unit 220 may regard that noise is detected, and newly detect a lane.

At this time, the lane detecting unit 220 may set the lane detection threshold in proportion to a height of the interested area. For example, in the embodiment of FIG. 9, the interested area may be y_{b}-yᵥ. Here, the lane detecting unit 220 may set the lane detection threshold in proportion to the interested area. For example, the lane detecting unit 220 may set the lane detection threshold relatively higher when the interested area has a greater height.

Meanwhile, the lane detecting unit 220 may draw two linear functional formulas like Equation 4. In other words, as shown in FIG. 9, within the interested area of the driving image, two lanes, namely a left lane and a right lane, are generally present based on the vehicle. Therefore, while moving the point t and the point d, the lane detecting unit 220 may draw a linear functional formula corresponding to the left lane and a linear functional formula corresponding to right lane, respectively. In this case, the lane detecting unit 220 may divide the interested area into a left interested area and a right interested area based on the line x=xᵥ, then find a single linear functional formula corresponding to the left lane in the left interested area, and find a single linear functional formula corresponding to the right lane in the right interested area.

The lane location analyzing unit 230 may analyze a location of a lane by using the interested area set by the interested area setting unit 240. In particular, the lane location analyzing unit 230 may analyze a point where the lane formula detected by the lane detecting unit 220 intersects the lower limit of the interested area set by the interested area setting unit 240 as a location of the lane. For example, in the embodiment of FIG. 9, the lane location analyzing unit 230 may regard a point d where the straight line corresponding to the lane meets the lower limit of the interested area as a location of the lane.

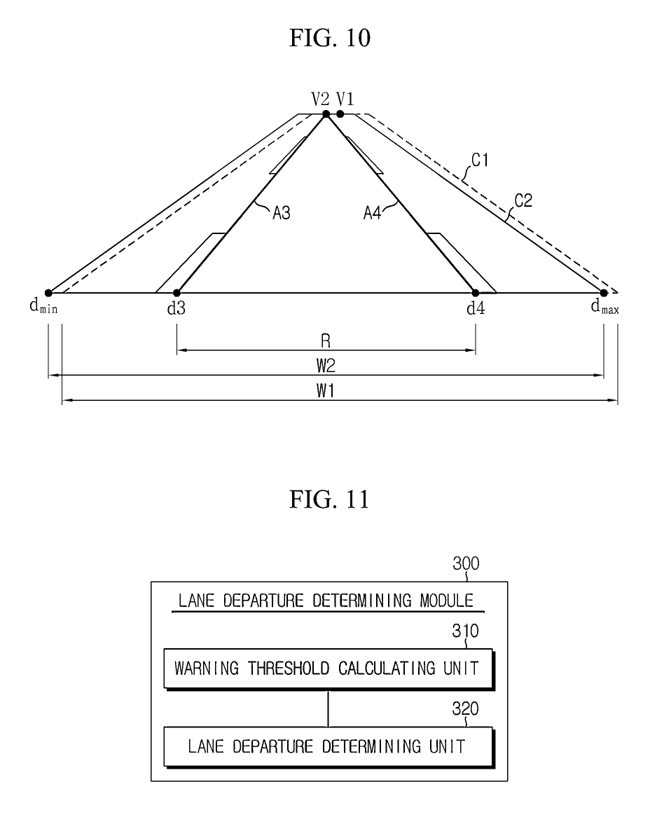

Meanwhile, as described above, the interested area setting unit 240 may correct an interested area set previously. Therefore, if two linear functional formulas are drawn as described above, the interested area setting unit 240 may regard an intersection point between the two drawn functions as a vanishing point, and correct the interested area based on the vanishing point. This will be described in more detail below with reference to FIG. 10.

FIG. 10 is a diagram schematically showing a process of correcting an interested area according to an embodiment of the present disclosure.

Referring to FIG. 10, a region marked by a dotted line C1 represents a preset interested area based on a predetermined vanishing point v1. The lane extracting module 100 and the lane recognizing module 200 may operate based on the interested area C1. At this time, the lane recognizing module 200 may extract lane edges and recognize straight lines corresponding thereto as A3 and A4 as indicated by FIG. 10.

If so, the interested area setting unit 240 regards an intersection point v2 of two straight lines A3 and A4 as a new vanishing point, and sets a new interested area based on the vanishing point v2 to correct an existing interested area. In other words, as indicated by a solid line C2 in FIG. 10, the interested area setting unit 240 may set a new interested area C2, different from the preset interested area C1. In addition, the interested area C2 newly set by the interested area setting unit 240 as described above may be used as an interested area for extracting and recognizing a lane in a driving image which is input later.

In addition, the interested area setting unit 240 may correct the interested area by using width information of the road.

For example, in the embodiment of FIG. 10, if straight lines A3 and A4 are detected by the lane detecting unit 220, a distance between the lines A3 and A4 in the lower limit of the interested area C1 may be a width of the road, expressed as R. At this time, if the width R of the road is different from a width of the road when the interested area C1 is determined before, the interested area setting unit 240 may adjust a width of the lower limit of the interested area. For example, if the newly recognized width R of the road is greater than a previous width of the road, the interested area setting unit 240 may set the interested area C2 so that a width W2 of the lower limit of the interested area C2 is greater than a width W1 of the lower limit of the interested area C1.

In addition, the interested area setting unit 240 may correct the interested area in consideration of the location of the lane, analyzed by the lane location analyzing unit 230. For example, in the embodiment of FIG. 10, the interested area setting unit 240 may determine a location of the left limit dₘᵢₙ of the lower limit, based on a point d3 where the straight line A3 meets the lower limit of the interested area. For example, when the point d3 moves to the left in comparison to a previous image, the interested area setting unit 240 may also move the point dₘᵢₙ to the left and set a new interested area C2. At this time, the interested area setting unit 240 may determine a moving distance of the point dₘᵢₙ based on the moving distance of the point d3. In addition, the interested area setting unit 240 may determine a location of the right limit dₘₐₓ of the lower limit, based on a point d4 where the straight line A4 meets the lower limit of the interested area.

If the interested area may be corrected by the interested area setting unit 240 as in this embodiment, when a view angle or installation position of a camera is changed like a detachable image photographing module 10, when a width of a road is changed, or when a vanishing point is changed due to a curvature of the road or a rotation of the vehicle, the interested area may be flexibly corrected. Therefore, in this aspect of the present disclosure, the interested area may be optimally maintained suitable for various environments, and thus it is possible to reduce an amount of calculations for recognizing a lane, which may improve a rate and accuracy for the lane extracting and recognizing work.

The lane departure determining module 300 determines lane departure of the vehicle by using the linear functional formula drawn by the lane recognizing module 200 according to the lane. In particular, the lane departure determining module 300 may determine lane departure by using slope information and location information of a line corresponding to the lane provided by the lane recognizing module 200.

FIG. 11 is a diagram schematically showing a functional configuration of the lane departure determining module 300 according to an embodiment of the present disclosure.

Referring to FIG. 11, the lane departure determining module 300 includes a warning threshold calculating unit 310 and a lane departure determining unit 320.

The warning threshold calculating unit 310 calculates a warning threshold value for a location of the lane. Here, the warning threshold value for a location of the lane may be regarded as a boundary value at which the location of the lane may be determined as lane departure of the vehicle.

The lane departure determining unit 320 analyzes the location of the lane analyzed by the lane location analyzing unit 230 of the lane recognizing module 200 and compares the analyzed location of the lane with the warning threshold value calculated by the warning threshold calculating unit 310. In addition, the lane departure determining unit 320 determines lane departure of the vehicle according to the comparison result. At this time, the lane departure determining unit 320 may use slope information together with the location information of the lane in order to determine lane departure.

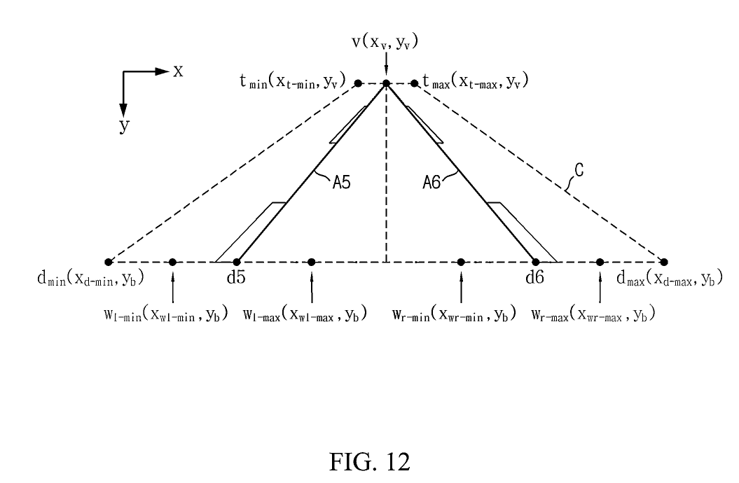

FIG. 12 is a diagram schematically showing a lane departure determining configuration of the lane departure determining module 300 to an embodiment of the present disclosure.

Referring to FIG. 12, the lane detecting unit 220 of the lane recognizing module 200 may detect a straight line A5 corresponding to a left lane or a straight line A6 corresponding to a right lane. In addition, the lane location analyzing unit 230 of the lane recognizing module 200 may analyze an intersection point d5 between the straight line A5 and the lower limit (y=y_{b}) of the interested area C as a location of the left lane and also analyze an intersection point d6 between the straight line A6 and the lower limit of the interested area C as a location of the right lane.

The warning threshold calculating unit 310 may calculate a maximum warning threshold value located at a right side of the lane and a minimum warning threshold value located at a left side of the lane. For example, as shown in FIG. 12, the warning threshold calculating unit 310 may set a minimum value of the warning threshold value for the left lane as a point Wₗ₋ₘᵢₙ (x_{wl-min}, y_{b}) and a maximum value as a point Wₗ₋ₘₐₓ (x_{wl-max}, y_{b}). In addition, the warning threshold calculating unit 310 may set a minimum value of the warning threshold value for the right lane as a point Wᵣ₋ₘᵢₙ (x_{wr-min}, y_{b}) and a maximum value as a point Wᵣ₋ₘₐₓ (x_{wr-max}, y_{b}).

At this time, the warning threshold calculating unit 310 may set the warning threshold value in consideration of the width of the road. For example, the warning threshold calculating unit 310 may calculate mean values of locations of lanes and vanishing points, and obtain left and right widths of the road by using the calculated mean locations of lanes and vanishing points. If so, the warning threshold calculating unit 310 may calculate a minimum value Wₗ₋ₘᵢₙ and a maximum value Wₗ₋ₘₐₓ of the left warning threshold value, based on the road left width information. In addition, the warning threshold calculating unit 310 may calculate a minimum value Wᵣ₋ₘᵢₙ and a maximum value Wᵣ₋ₘₐₓ of the right warning threshold value, based on the road right width information. As described above, in the embodiment where the warning threshold value is calculated in proportion to a road width, the warning threshold value may be adaptively changed depending on various variable factors such as a camera view angle, a camera installation location or the like.

In particular, the warning threshold calculating unit 310 may set the warning threshold value in proportion to a width of the road. For example, if it is determined that a width of a road at a current image is greater than a width of a road at a previous image, the warning threshold calculating unit 310 may set the minimum value Wₗ₋ₘᵢₙ and the maximum Wₗ₋ₘₐₓ of the left warning threshold value to be moved to the left and/or set the minimum value Wᵣ₋ₘᵢₙ and the maximum value Wᵣ₋ₘₐₓ of the right warning threshold value to be moved to the right.

If the warning threshold value is calculated by the warning threshold calculating unit 310 as described above, the lane departure determining unit 320 may determine lane departure by using the location information and the slope information of the lane. In other words, if the location of the lane moves from the left side of the maximum warning threshold value to the right side thereof or moves from the right side of the minimum warning threshold value to the left side thereof, the lane departure determining unit 320 may determine that the vehicle makes lane departure.

For example, in FIG. 12, if a location d5 of a left lane moves from a right side of the left minimum warning threshold value Wₗ₋ₘᵢₙ to a left side, the lane departure determining unit 320 may determine that the vehicle makes lane departure. In addition, if the location d5 of the left lane moves from a left side of the left maximum warning threshold value Wₗ₋ₘₐₓ to a right side, the lane departure determining unit 320 may determine that the vehicle makes lane departure.

In addition, if a location d6 of a right lane moves from a right side of the right minimum warning threshold value Wᵣ₋ₘᵢₙ to a left side or moves from a left side of the right maximum warning threshold value Wᵣ₋ₘₐₓ to a right side, the lane departure determining unit 320 may determine that the vehicle makes lane departure.

The lane departure warning system according to the present disclosure may further include a warning module 400. The warning module 400 provides warning information to a user if the lane departure determining module 300 determines that the vehicle makes lane departure.

At this time, the warning module 400 may provide lane departure information of the vehicle in various ways, for example in a visual, acoustic or tactile manner. For example, the warning module 400 may include a display such as LCD or an LED lamp to visually provide warning information to the user. In addition, the warning module 400 may include a speaker to audibly provide warning information to the user. If the warning module 400 is to provide warning information visually or audibly to the user as described above, other instruments equipped in the vehicle, for example a black box or a navigation device, may be used. In addition, the warning module 400 may include a vibrating unit at a vehicle handle or seat to provide warning information to the user by vibrating the vehicle handle or seat when the vehicle makes lane departure.

Meanwhile, the lane recognizing module 200 may recognize various kinds of lanes distinguishably. General road marks may be classified into a centerline, a general lane, a shoulder line, a line for limiting the change of course, a U-turn line, an exclusive lane, a guide lane or the like. In addition, lanes may be classified into a broken line, a solid line, a double line or the like. Such lanes may have different colored lengths, vacant lengths, widths, colors or the like. Therefore, for example, the lane recognizing module 200 may store relevant information in advance and distinguish kinds of recognized lanes.

In particular, the lane recognizing module 200 may recognize a centerline, distinguishably from a general lane. For example, a centerline may be a solid line having a width of 15 to 20 cm, and a general lane may have a width of 10 to 15 cm. In this case, the lane recognizing module 200 may distinguish whether the recognized lane is a centerline or a general lane in consideration of the width of the lane edge. In this case, the lane recognizing module 200 may give different kinds of warning information to the warning module 400 when the vehicle invades a centerline and when the vehicle invades a general lane. If so, the warning module 400 may give warning information differently by distinguishing whether the vehicle invades a centerline or a general lane. For example, the warning module 400 may give a warning sound more loudly when the vehicle invades a centerline, in comparison to the case where the vehicle invades a genera lane.

In this configuration of the present disclosure, the possibility of big accident may be greatly lowered. Since a traffic accident caused by a vehicle invading a centerline may give a great damage in comparison to a traffic accident caused by a vehicle invading a general lane, if a more critical alarm is generated when a vehicle invades a centerline as in the above embodiment, a user may pay more attention thereto.

In addition, the lane recognizing module 200 may distinguishably recognize a solid line and a broken line. For example, the lane recognizing module 200 may distinguish whether a recognized lane is a solid line or a broken line, based on the number of pixels of a straight line corresponding to a lane, which overlap with a lane edge. In addition, the lane recognizing module 200 may provide the distinguished information to the warning module 400. If so, the warning module 400 may give warning information differently by distinguishing whether the vehicle invades a solid line or a broken line. For example, the warning module 400 may give a warning sound more loudly when the vehicle invades a solid line, in comparison to the case where the vehicle invades a broken line.

Generally, a broken line allows a vehicle to change lanes depending on the situation, for example when overtaking, but a solid line does not allow a vehicle to change lanes in many cases. Therefore, in the embodiment where the lane recognizing module 200 and the warning module 400 give warning information to the user after distinguishing whether the vehicle invades a broken line or a solid line, the user may pay more attention when the vehicle invades a solid line, which may reduce accident frequency and damage degree.

Operations of the lane departure warning system according to the present disclosure will be described.

For example, when a vehicle starts running and the lane departure warning system also starts operating, an interested area may be initially set, if there is no interested area set before.

Since there may be no information about a vanishing point and a lane at an initial stage, in this case, the lane departure warning system searches the entire image to detect lanes and a vanishing point. In other case, if it is determined that there is no information about a lane and a vanishing point as described above or there is information which is however erroneous, the lane departure warning system may assume that the vanishing point is present at the center of the image.

In addition, the lane departure warning system may search a location of a hood from a point spaced apart downwards from the assumed or detected vanishing point as much as predetermined pixels by using a horizontal edge detecting algorithm. If a hood is not detected, the lane departure warning system may regard that a hood is not photographed in the image.

In addition, the lane departure warning system may detect a lane based on the assumed or detected vanishing point. At this time, if a lane is not detected, the lane departure warning system may repeat a process of assuming a vanishing point and detecting a lane for neighboring pixels.

If two lanes at both sides of a vehicle are not entirely detected even though the entire image is searched, the lane departure warning system may regard that the vehicle is not on a running lane and stand by for a predetermined time. However, if two lanes at both sides are entirely detected, the lane departure warning system may calculate an intersection point between a linear functional formula for the left lane and a linear functional formula for the right lane as a vanishing point. Next, the lane departure warning system may set an interested area by using the calculated vanishing point and locations of the detected lane and hood, and apply the set interested area to a present image and/or a next image.

After that, the lane departure warning system may extract a candidate lane from an image within the interested area, and draw a linear functional formula corresponding to the candidate lane for the image within the interested area to analyze a location of the lane. At this time, the analyzed location information of the lane may be used for correcting the interested area, and the corrected interested area may be applied to a present image frame and/or a next image frame.

If the location of the lane is analyzed as described above, the lane departure warning system may determine lane departure by using the location, slope information or the like of the lane, and if it is determined that the vehicle makes lane departure, the lane departure warning system may warn the user by giving the lane departure information.

Meanwhile, each component of the lane departure warning system according to the present disclosure may be implemented as a separate independent device.

Meanwhile, the lane departure warning system according to the present disclosure may be implemented in various device forms. For example, the lane departure warning system may be configured to be implemented in a black box or a navigation device equipped in a vehicle. In this case, the black box or navigation device may include the lane departure warning system according to the present disclosure.

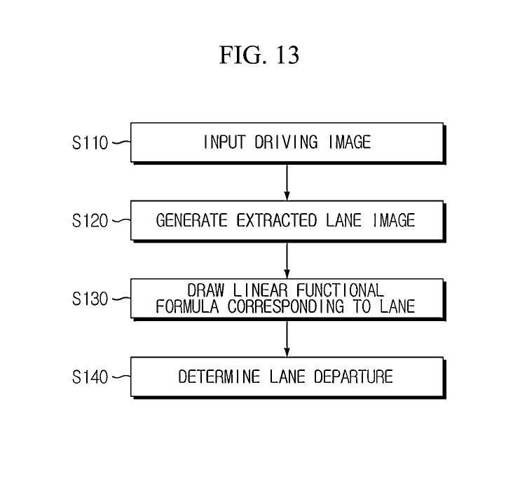

FIG. 13 is a flowchart for illustrating a method for warning lane departure according to an embodiment of the present disclosure. In FIG. 13, a subject performing each step may be regarded as a component of the lane departure warning system.

As shown in FIG. 13, in the method for warning lane departure according to the present disclosure, first, a driving image of a vehicle is input from an image photographing module (S110), and an extracted lane image is generated by removing an image other than a lane from the input image to extract a lane (S120). In addition, in the extracted lane image generated as above, a linear functional formula corresponding to the extracted lane is drawn (S130). After that, it is determined whether the vehicle makes lane departure by using the drawn linear functional formula (S140).

Preferably, before Steps S120 or S130, a setting step of, for example, correcting an interested area, may be further included. In this case, Steps S120 and S130 may be performed based on the set interested area.

The present disclosure has been described in detail. However, it should be understood that the detailed description and specific examples, while indicating embodiments of the disclosure, are given by way of illustration only, since various changes and modifications within the spirit and scope of the disclosure will become apparent to those skilled in the art from this detailed description.

Meanwhile, even though this specification uses the term ‘module’ for components such as the ‘lane extracting module’, the ‘lane recognizing module’, the ‘lane departure determining module’ or the like and also uses the term ‘unit’ for components such as the ‘road brightness calculating unit’, the ‘brightness-based filtering unit’, the ‘width-based filtering unit’, the ‘lane edge extracting unit’, the ‘lane detecting unit’, the ‘lane location analyzing unit’, the ‘interested area setting unit’ or the like, they are just used for expressing logic components and do not represent components which must be physically dividable or physically divided, as obvious to those skilled in the art.

In other words, in the present disclosure, each component corresponds to a logic element for implementing the technical spirit of the present disclosure, and thus even though some components are integrated or any component is divided, this should be interpreted as falling within the scope of the present disclosure as long as the function performed by the logic component of the present disclosure can be realized. In addition, if any component performs a similar or identical function, this should be interpreted as falling within the scope of the present disclosure regardless of the consistency of its name.

What is claimed is:

1. A system for warning lane departure, comprising:
a lane extracting module configured to receive a driving image of a vehicle from an image photographing module and generate an extracted lane image by removing an image other than a lane from the driving image at least partially to extract a lane;
a lane recognizing module configured to draw a linear functional formula corresponding to the extracted lane from the extracted lane image generated by the lane extracting module; and
a lane departure determining module configured to determine lane departure of a vehicle by using the linear functional formula drawn by the lane recognizing module.

2. The system for warning lane departure according to claim 1,
wherein the lane extracting module receives the driving image as a gray image from the image photographing module, and generates the extracted lane image as a binary-coded image.

3. The system for warning lane departure according to claim 2, wherein the lane extracting module includes:
a road brightness calculating unit configured to receive the gray image and calculate a brightness threshold;
a brightness-based filtering unit configured to extract pixels having brightness over the brightness threshold from the gray image and generate a binary-coded image by using only the extracted pixels; and
a width-based filtering unit configured to compare widths of the pixels extracted by the brightness-based filtering unit with a reference width range and remove a pixel having a width out of the reference width range from the binary-coded image.

4. The system for warning lane departure according to claim 3,
wherein the road brightness calculating unit divides a portion corresponding to a road into a plurality of regions, calculates mean pixel brightness in each region, and calculates a brightness threshold based on the mean pixel brightness.

5. The system for warning lane departure according to claim 3,
wherein the width-based filtering unit calculates a ratio of a lane width to a road width, compares the calculated ratio with a reference ratio range, and removes a pixel whose ratio is out of the reference ratio range from the binary-coded image.

6. The system for warning lane departure according to claim 1, wherein the lane recognizing module includes:
a lane edge extracting unit configured to extract a lane edge of the extracted lane from the extracted lane image;
a lane detecting unit configured to draw a linear functional formula between x and y, corresponding to the extracted lane edge, based on an X-Y coordinate system in which a horizontal axis of the extracted lane image is an x axis and a vertical axis is a y axis; and
a lane location analyzing unit configured to analyze a location of the lane by using the linear functional formula drawn.

7. The system for warning lane departure according to claim 6,
wherein the lane recognizing module further includes an interested area setting unit configured to set an interested area for the image by using the linear functional formula drawn by the lane detecting unit, and
wherein lane extracting module extracts the lane within the interested area set by the interested area setting unit.

8. The system for warning lane departure according to claim 7,
wherein when two linear functional formulas are drawn by the lane detecting unit, the interested area setting unit calculates an intersection point of the two linear functional formulas as a vanishing point, and sets the interested area by using the calculated vanishing point.

9. The system for warning lane departure according to claim 8,
wherein the interested area setting unit sets a y-axis coordinate value of the vanishing point as a y-axis coordinate upper limit of the interested area, searches a y-axis coordinate value of a hood of the vehicle, and sets the y-axis coordinate value of the hood as a y-axis coordinate lower limit of the interested area.

10. The system for warning lane departure according to claim 8,
wherein the interested area setting unit corrects a preset interested area by using a location of the vanishing point and width information of a road.

11. The system for warning lane departure according to claim 7,
wherein the lane detecting unit draws a following equation as the linear functional formula between x and y:
x=a×(y−y_{b})+x_{d}
where x and y are variables, a is a constant representing a ratio of an increment of x to an increment of y, y_{b} represents a y-axis coordinate lower limit of the interested area, and x_{d} represents a x-axis coordinate value of the linear functional formula at a lower limit of the interested area.

12. The system for warning lane departure according to claim 11,
wherein the lane detecting unit moves a point t located at an upper limit of the interested area and a point d located at the lower limit of the interested area in a horizontal direction, respectively, and when a number of pixels overlapping with the lane edge extracted by the lane edge extracting unit is greatest, an equation between x and y for a line connecting the points t and d is drawn as the linear functional formula.

13. The system for warning lane departure according to claim 12,
wherein the lane detecting unit draws the linear functional formula as an equation
$$x = \frac{( {x}_{d} - {x}_{t} )}{( {y}_{b} - {y}_{v} )} \times ( y - {y}_{b} ) + {x}_{d} ,$$
where x and y are variables, xₜ and yᵥ represent an x-axis coordinate value and a y-axis coordinate value of the point t, and x_{d} and y_{b} represent an x-axis coordinate value and a y-axis coordinate value of the point d.

14. The system for warning lane departure according to claim 1, wherein the lane departure determining module includes:
a warning threshold calculating unit configured to calculate a warning threshold value for a location of the lane; and
a lane departure determining unit configured to compare the location of the lane recognized by the lane recognizing module with the warning threshold value calculated by the warning threshold calculating unit and determine lane departure based on a result of comparing the location of the lane with the warning threshold value.

15. The system for warning lane departure according to claim 14,
wherein the warning threshold calculating unit calculates the warning threshold value in proportion to a width of a road.

16. The system for warning lane departure according to claim 14,
wherein the warning threshold calculating unit calculates a maximum warning threshold value located at a right side of the lane and a minimum warning threshold value located at a left side of the lane, and
wherein the lane departure determining unit determines that the vehicle makes lane departure when the location of the lane moves from a left side of the maximum warning threshold value to the right side of the maximum warning threshold value or moves from the right side of the minimum warning threshold value to a left side of the minimum warning threshold value.

17. The system for warning lane departure according to claim 1, further comprising:
a warning module configured to provide a user with warning information when the lane departure determining module determines that the vehicle makes lane departure.

18. A method for warning lane departure, comprising:
receiving a driving image of a vehicle from an image photographing module;
generating an extracted lane image by removing an image other than a lane from the driving image at least partially to extract a lane;
drawing a linear functional formula corresponding to the extracted lane from the extracted lane image generated above; and
determining lane departure of a vehicle by using the linear functional formula drawn.
